(19) United States
(12) Patent Application Publication
(10) Pub. No.: US 2026/0073279 A1
(43) Pub. Date: Mar. 12, 2026

(54) CONTENT DISTRIBUTION BASED ON CAUSAL RELATIONSHIP DATA

(71) Applicant: ADOBE INC., SAN JOSE, CA (US)

(72) Inventors: James William Snyder, JR., Sunnyvale, CA (US); Amirhossein Meisami, Menlo Park, CA (US); Yunjie Chen, Sunnyvale, CA (US); Anish Narang, San Francisco, CA (US); Mihir Naware, Princeton, NJ (US); Roger Brooks, Palo Alto, CA (US)

(21) Appl. No.: 18/828,658

(22) Filed: Sep. 9, 2024

(51) Int. Cl. G06N 20/00

(52) U.S. Cl. CPC G06N 20/00

(57) ABSTRACT

A method, apparatus, non-transitory computer readable medium, and system for data processing include obtaining data from a software application, where the data includes one or more of content data, interaction data, profile data, and factor data, generating shadow data corresponding to the data by duplicating the data and randomly reassigning feature values of the duplicated data, selecting one or more prominent features by comparing the data and the shadow data, computing causal relationship data for the data by optimizing a plurality of edges on one or more graphs based on the one or more prominent features, and providing content to a user via the software application based on the causal relationship data.

### BACKGROUND

Entities commonly use data processing techniques to track values of a variety of targeted data items to determine progress towards a goal, and what content to provide to users to promote the progress towards the goal. However, tracking these values is difficult, and therefore diminishes entities' ability to make proactive decisions about what content should be provided.

Some conventional data processing systems may attempt to perform proactive data analysis to understand how some items of data influence others using correlation analysis or Bayesian statistical methods. However, correlation analysis is relatively inaccurate because it does not attempt to control for confounders, while Bayesian statistical methods are relatively inaccurate, inefficient, and not scalable because they rely on assumptions and pre-specifications of input data, which can also have a distorting effect on the methods' predictions.

### SUMMARY

Systems and methods are provided for providing content to users based on causal relationship data identified by a machine learning model for an input dataset. The causal relationship data indicates a causal relationship, or an extent or degree to which one item of the input data set influences an occurrence of another item of the input data set. The causal relationship data is identified based on relevant data items of the input dataset, thereby increasing an accuracy of the machine learning model.

The machine learning model determines the causal relationship data by iteratively optimizing edges of one or more graphs, where nodes of the graphs respectively correspond to the relevant data items, edges connecting a pair of nodes indicate that a causal relationship exists between a corresponding pair of relevant data items, and a magnitude of the edge indicates a strength of the causal relationship in the data. The causal relationship data corresponds to the strength of the causal relationship.

The causal relationship data is more accurate than predictions obtained using correlation analysis because the machine learning model properly controls for various confounders. Furthermore, the machine learning model is more accurate, efficient and easier to deploy than conventional processes that use Bayesian statistics because the machine learning model does not rely on assumptions and pre-specifications about the input dataset. Embodiments of the present disclosure can therefore identify and provide content to users based on the causal relationship data, such that the content would tend to promote an occurrence of a target event once it is received by a user.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 shows an example of a data processing system according to aspects of the present disclosure.

FIG. 2 shows an example of a method for providing customized content according to aspects of the present disclosure.

FIG. 3 shows an example of an implementation of a data processing system for providing content based on causal relationship data according to aspects of the present disclosure.

FIG. 4 shows an example of a heat map representation of one or more graphs according to aspects of the present disclosure.

FIG. 5 shows an example of cohort modeling according to aspects of the present disclosure.

FIG. 6 shows an example of a representation of an action recommendation for an optimized free user web journey according to aspects of the present disclosure.

FIG. 7 shows an example of an implementation of a data processing system for obtaining data based on preliminary data according to aspects of the present disclosure.

FIG. 8 shows an example of an implementation of a data processing system for generating forecasted data according to aspects of the present disclosure.

FIG. 9 shows an example of an implementation of a data processing system for obtaining a contribution analysis according to aspects of the present disclosure.

FIG. 10 shows an example of a representation of a contribution analysis as a time series according to aspects of the present disclosure.

FIG. 11 shows an example of a method for providing content based on causal relationship data according to aspects of the present disclosure.

FIG. 12 shows an example of a method for training a machine learning model according to aspects of the present disclosure.

FIG. 13 shows an example of a data processing apparatus according to aspects of the present disclosure.

### DETAILED DESCRIPTION

### Overview

Data can be organized into “features”, i.e., measurable data attributes organized by a unique object ID such as user IDs, timestamps, etc. Organizations use data analytics platforms to track target features to determine progress towards their goals. Then, content systems can provide users appropriate content to meet those goals. However, accurately tracking relationships among different features is difficult. Accordingly, embodiments of the present disclosure include systems and methods that accurately identify causal relationships among data features and provide users appropriate content based on the causal relationships. Some embodiments use a causal forest machine learning model to compute the causal relationships.

An example feature is “user access of a website”, where the feature value can be a number of times that a user accessed the website. The features of data can be organized according to columns corresponding to different features and rows corresponding to the object IDs. Causal relationships among the features indicate an extent or degree to which one feature (e.g., one column of data) influences values of another feature. For example, causal relationship data may include a likelihood that one unit of a feature value will increase or decrease another feature value. Causal relationship data is computed by a machine learning model based on identified prominent (e.g., relevant) features of input data, where the prominent features have predictive power and thereby increase the accuracy of the machine learning model.

There are often an extremely large number of variables such as target features, metrics, and user profile variables to track, and it is often unclear which variables are impactful on progress towards the goal, and to what extent they are impactful. Proactive decision-making about what actions an entity should take can therefore be difficult to make, and an entity may instead be forced to reactively correct mistakes based on past performance.

Some conventional data processing systems may attempt to perform proactive data analysis to understand how some items of data influence others using correlation analysis or Bayesian statistical methods. However, correlation analysis is relatively inaccurate because it does not control for potential confounders. Bayesian statistical methods are difficult to scale because they rely on assumptions and pre-specifications of input data, which can also have a distorting effect on the methods' predictions.

Accordingly, embodiments of the present disclosure use a machine learning model to determine the causal relationship data by iteratively optimizing edges of one or more graphs, where nodes of the graphs respectively correspond to the prominent features, edges connecting a pair of nodes indicate that a causal relationship exists between a corresponding pair of features, and a weight (e.g., a magnitude) of the edge indicates the strength of the causal relationship and is represented by the causal relationship data. The resulting causal relationship data is more accurate and scalable than predictions obtained using Bayesian statistics, because the machine learning model does not rely on assumptions and pre-specifications about the data. Furthermore, the graph optimization approach employed by the machine learning model is non-parametric, and is therefore more flexible and less sensitive to a presence of unobserved confounders as compared to correlation analysis processes that rely on more rigid structural assumptions. Finally, the output of the machine learning model is robust, interpretable, and user-friendly.

The data processing system can therefore identify and provide content, based on the causal relationship data, that would tend to promote an occurrence of a target feature once it is received by a user. The likelihood of the effectiveness of the content is increased due to the accuracy of the causal relationship data. Accordingly, embodiments of the present disclosure include systems and methods that improve on conventional data processing technology, as the systems and methods provide allows content to be provided to users with a confidence that could not be obtained but for the accuracy of the causal relationship data provided by the machine learning model.

According to some aspects, the data processing system handles a problem of high cardinality in input data by automatically pre-selecting important features of the data, thereby reducing a scale of the data, and by identifying different graphs based on different forecast time horizons, where the features then correspond to specific forecast time horizons and prior features are used as heterogeneity factors. For example, in some embodiments, the machine learning model computes the causal relationship data according to a time frame of the causal relationship, therefore allowing content to be provided on a granular, time-sensitive basis.

According to some aspects, a testing schema is provided that allows for a validation of the causal relationship data for incentivized interactions through personalized campaign design and A/B testing. According to some aspects, the data processing system generates new features via episode modeling, which uses one or more artificial neural networks (ANNs) to find common sequences of features that are related to higher-level behavior. In some embodiments, the episode modeling therefore allows a target feature to be discovered.

In some embodiments, the machine learning model identifies user cohorts based on differences in causal relationship data among the user cohorts, thereby identifying specific categories of users that can be more directly targeted with content. In an example, the machine learning model discovers cyclical relationships in addition to acyclic relationships by using time-lagged feature representations, and is therefore not only capable of identifying significant drivers for any given user segment but also capable of discovering significant segments for any given combination of features, which is helpful in understanding a diversity of user behavior in response to certain actions.

According to some aspects, the data processing system deploys the output of the machine learning model in other target feature modeling capabilities, such as propensity modeling, forecasting, contribution analysis, action recommendation, and/or scenario modeling, with capabilities that extend beyond conventional data processing systems. In one example, the data processing system forecasts future values of one or more target features based on the causal relationship data, helping a user to determine if the future values will deviate from target future values and determine a best response action if so. In another example, the data processing system uses contribution analysis based on the causal relationship data to understand why a target feature value was less than expected, thereby helping a user to perform response actioning.

### Terminology Examples

“Data” refers to a set of information. The data can include one or more features. A “feature” is a measurable property of data, or a discreet item of data, where the feature is measured according to a “feature value”. Data can be organized into a table sequence of columns in multiple ways. In one example, a feature (e.g., “project upload”) can be represented as a column, and a feature value (e.g., “number of times the project is uploaded”) is a cell in the column. In another example, a feature can be a cell in a column of features, where each cell is an indication of one unit of a value of the feature. For example, a table can include an “Event Type” column, where each cell in the Event Type column is a different feature. In either example, each feature can be included in rows corresponding to a related index (such as a user ID, a timestamp, a software application, etc.).

The data includes one or more of “content data”, “interaction data”, “profile data”, and “factor data”. Content data describes content that a user receives, provides, or manipulates on a software application. Interaction data relates to interactions between a user (or an entity) and a software application, including events on the software application, such as accesses, log-ins, clicks, referrals, uploads, downloads, time spent on portions of the software application, purchases, etc. Interaction data can also relate to interactions between users and entities on the software application.

Profile data relates to generally immutable or rarely changing characteristics of a user or entity, such as a geolocation of a user or a type of industry of an entity. Factor data relates to background data that might impact a user or entity, and can be internal (e.g., derived from a software application associated with an entity) or external (e.g., derived from a software application that is not associated with an entity). Examples of external factor data include financial indices, census data, etc. Examples of internal factor data include aggregate proxy variables for software applications for which there is no user-level interaction data available.

A “software application” refers to any computer program that executes computer code to perform a task for a user of the software application. Examples of a software application include a web browser, a smartphone or tablet app, an executable personal computer program, etc. A “user” refers to an individual user of the software application, or an individual user who employs the data processing system to perform the various functions described herein. An “entity” refers to a group of users or an organization that employs the data processing system to perform the various functions described herein.

“Shadow data” refers to data including randomized feature values for the purpose of determining prominent features of the data. “Prominent features” refer to features that the data processing system identifies as being relevant for use by the machine learning model.

A “graph” refers to a collection of at least one node and at least one edge, in which an edge is connected to a node. One or more graphs can be an output of the machine learning model. One or more graphs can be considered to be the machine learning model. “Causal relationship data” refers to data indicating an extent or degree to which one feature influences an occurrence of another feature (e.g., a percent likelihood that one unit of a feature value will increase or decrease another feature value). In an example, nodes of the graphs respectively correspond to the prominent features, edges connecting a pair of nodes indicate that a causal relationship exists between a corresponding pair of features, and a weight (e.g., a magnitude) of the edge indicates the strength of the causal relationship and is represented by the causal relationship data.

“Content” refers to any discrete combination of media, such as text, images, audio, video, etc. Examples of content include emails and other messages, image files, audio files, video files, multimedia files, etc.

An example of the present disclosure is used in a content distribution context. In the example, the data processing system collects data from a variety of software applications, such as websites and smartphone apps. The data processing system processes the data to identify the most relevant features of the data. The data processing system uses the machine learning model to determine causal relationship data for the relevant features. The causal relationship data indicates that users who upload a project (e.g., a first feature) to website A. com using a particular web browser within a week of first logging in to A. com will be 12% more likely (e.g., causal relationship data) to be a return monthly active user (e.g., a second feature) of A. com. Therefore, the data processing system provides multimedia messages (e.g., content) to users of A. com via the particular web browser during the users'first week of being logged-in to A.com, encouraging the users to upload projects. Accordingly, the content provided by the data processing apparatus allows an entity that operates A.com to progress in an informed manner toward a goal of increasing a number of returning active monthly users.

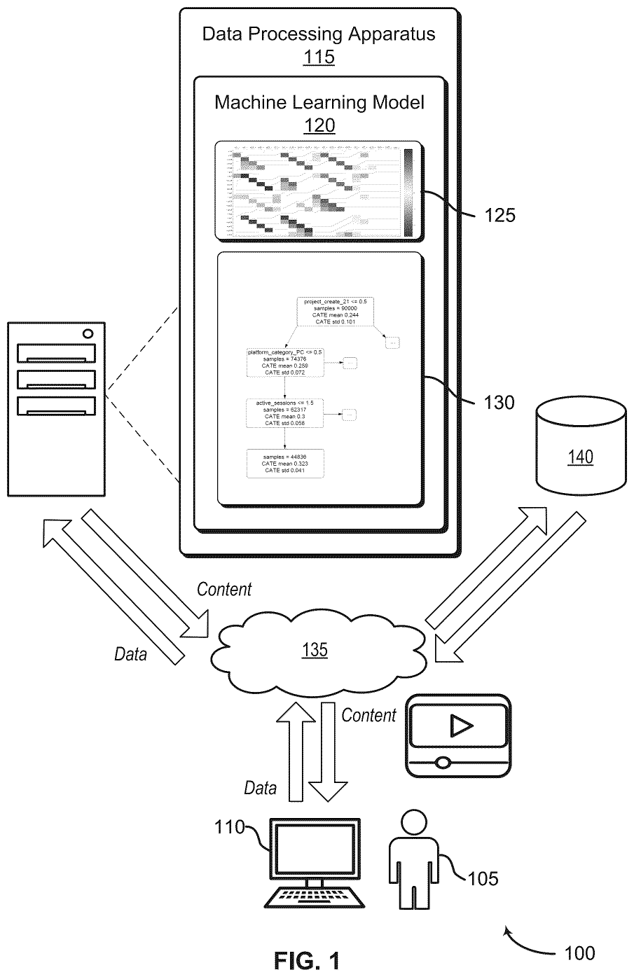

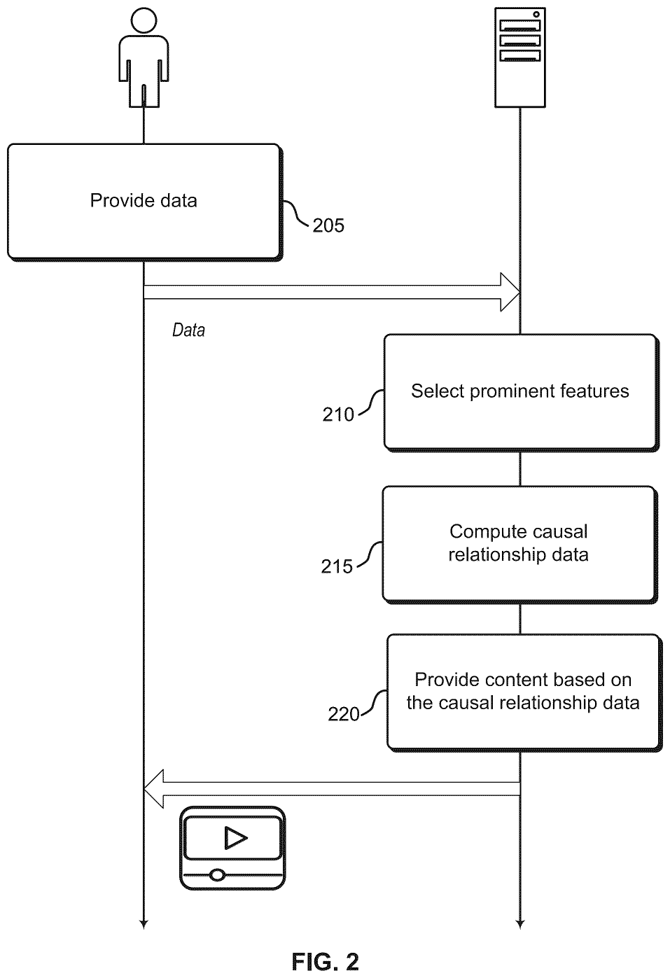

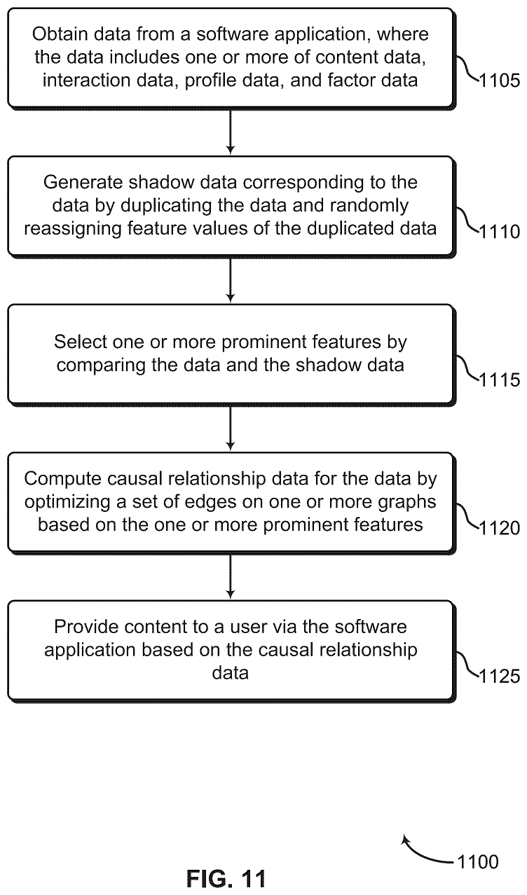

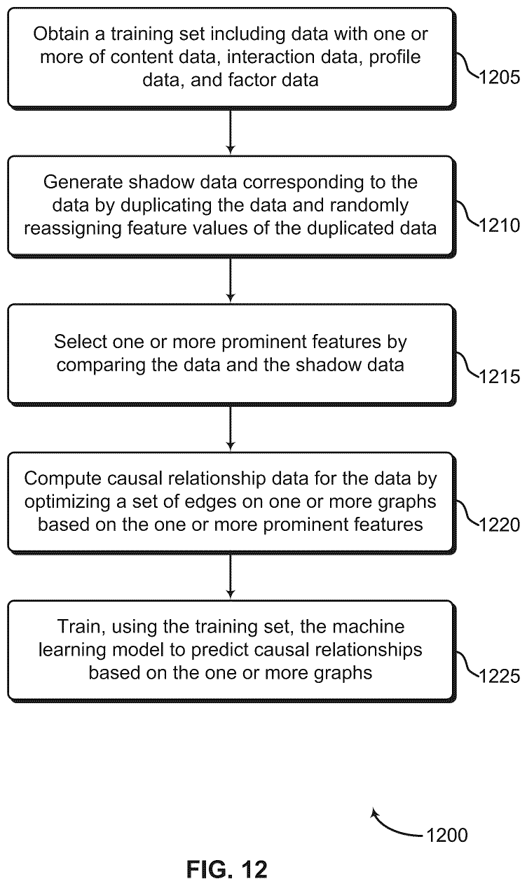

Further example applications of the present disclosure in the content distribution context are provided with reference to FIGS. 1-2. Details regarding the architecture of the data processing system are provided with reference to FIGS. 1-10 and 13. Examples of a process for providing content based on causal relationship data are provided with reference to FIG. 11. Examples of a process for training a machine learning model are provided with reference to FIG. 12.

### Data Processing System

FIG. 1 shows an example of a data processing system 100 according to aspects of the present disclosure. The example shown includes data processing system 100, user 105, user device 110, graph representation 125, and chart representation 130. In one aspect, data processing system 100 includes data processing apparatus 115, cloud 135, and database 140. In one aspect, data processing apparatus 115 includes machine learning model 120.

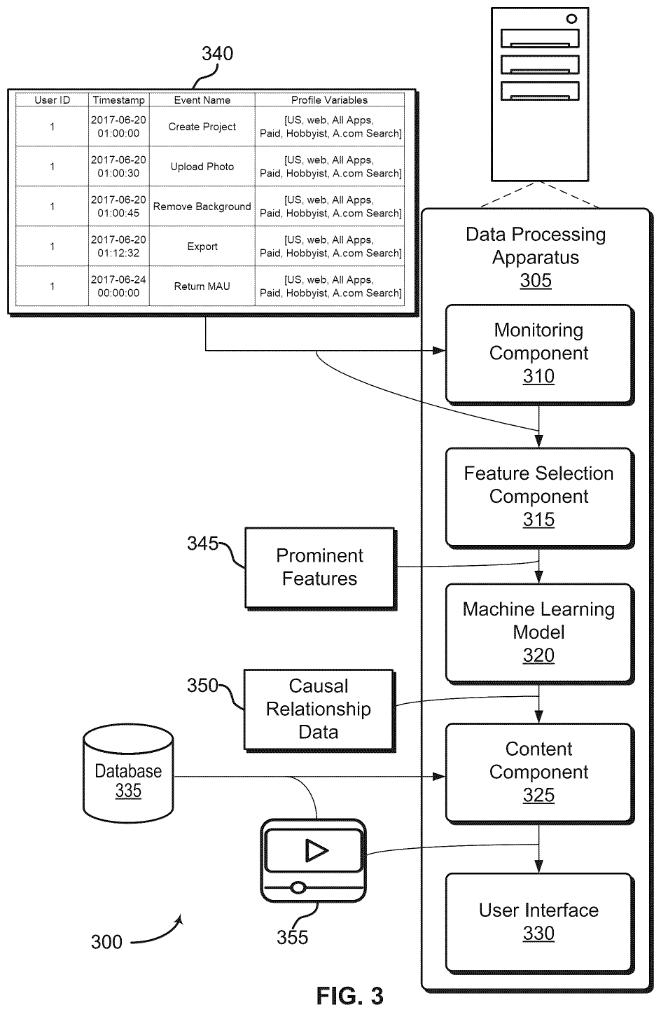

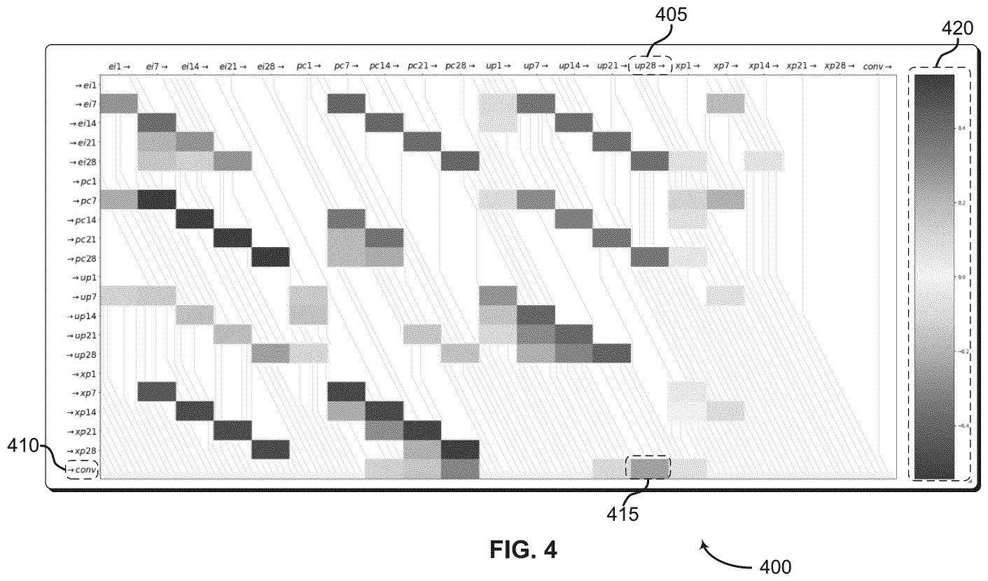

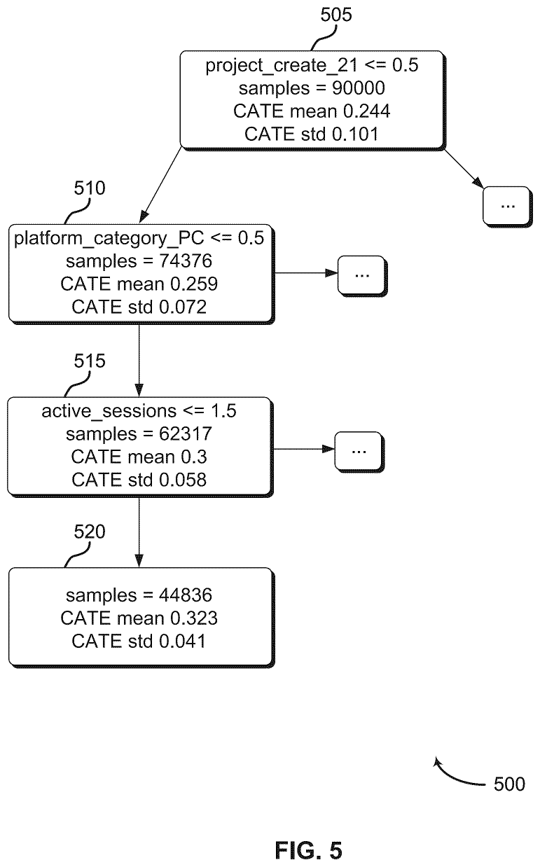

In the example of FIG. 1, data processing apparatus 115 receives data from user 105 via a user interface provided by data processing apparatus 115 on user device 110. Data processing apparatus 115 uses machine learning model 120 to generate a graph (e.g., represented as a heat map by graph representation 125) that indicates causal relationship data between an item of data and a target item of data. The graph is described in further detail with reference to FIGS. 3 and 4. Machine learning model 120 can use the causal relationship data to identify a chart of user clusters (e.g., represented by chart representation 130). The chart of user clusters is described in further detail with reference to FIGS. 3 and 5. Data processing apparatus 115 uses the causal relationship data identified by the graph to identify content associated with the causal relationship data, and provides the content to user 105 via the user interface.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface, a text-based interface, or a combination thereof) provided by data processing apparatus 115. In some aspects, the user interface allows information to be communicated between user 105 and data processing apparatus 115.

According to some aspects, a user device user interface enables user 105 to interact with user device 110. In some embodiments, the user device user interface includes an audio device, such as an external speaker system, an external display device such as a display screen, or an input device (e.g., a remote-control device interfaced with the user interface directly or through an I/O controller module). In some embodiments, the user device user interface includes a graphical user interface, a text-based interface, or a combination thereof.

According to some aspects, data processing apparatus 115 includes a computer-implemented network. In some embodiments, the computer-implemented network includes machine learning model 120. In some embodiments, data processing apparatus 115 also includes at least one processor, a memory subsystem, a communication interface, an I/O interface, at least one user interface component, and a bus. Additionally, in some embodiments, data processing apparatus 115 communicates with user device 110 and database 140 via cloud 135.

According to some aspects, data processing apparatus 115 is implemented on a server. A server provides at least one function to users linked by way of one or more of various networks, such as cloud 135. In some embodiments, the server includes a single microprocessor board, which includes a microprocessor responsible for controlling all aspects of the server. In some embodiments, the server uses microprocessor and protocols to exchange data with other devices or users on one or more of the networks via at least one protocol, such as hypertext transfer protocol (HTTP), simple mail transfer protocol (SMTP), file transfer protocol (FTP), simple network management protocol (SNMP), and the like.

According to some aspects, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Further detail regarding the architecture of data processing apparatus 115 is provided with reference to FIGS. 2-10 and 13. Further detail regarding a process for natural language query filtering are provided with reference to FIG. 11. Further detail regarding a process for providing content based on causal relationship data is provided with reference to FIG. 12. Further detail regarding a process for training a machine learning model is provided with reference to FIG. 12.

Cloud 135 is a computer network configured to provide on-demand availability of computer system resources, such as data storage and computing power. In some examples, cloud 135 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some examples, cloud 135 is limited to a single organization. In other examples, cloud 135 is available to many organizations.

In one example, cloud 135 includes a multi-layer communications network comprising multiple edge routers and core routers. In another example, cloud 135 is based on a local collection of switches in a single physical location. According to some aspects, cloud 135 provides communications between user device 110, data processing apparatus 115, and database 140.

Database 140 is an organized collection of data. In an example, database 140 stores data in a specified format known as a schema. According to some aspects, database 140 is structured as a single database, a distributed database, multiple distributed databases, or an emergency backup database. Data storage and processing in database 140 is manageable by a database controller, which can be operated by a user or automatically without interaction from the user. In some examples, database 140 is external to data processing apparatus 115 and communicates with data processing apparatus 115 via cloud 135. In other examples, database 140 is included in data processing apparatus 115.

Data processing system 100 is an example of, or includes aspects of, the corresponding element described with reference to FIGS. 3, 7, 8, and 9. Data processing apparatus 115 is an example of, or includes aspects of, the corresponding element described with reference to FIGS. 3, 7, 8, 10, and 13. Machine learning model 120 is an example of, or includes aspects of, the corresponding element described with reference to FIGS. 3, 8, 10, and 13. Database 140 is an example of, or includes aspects of, the corresponding element described with reference to FIG. 3.

FIG. 2 shows an example of a method 200 for providing customized content according to aspects of the present disclosure. Referring to FIG. 2, a data processing system (such as the data processing system 300 described with reference to FIG. 3) provides content to a user based on causal relationship data obtained using a causal inference machine learning model (such as the machine learning model 320 described with reference to FIG. 3). In one example, the data processing system obtains data from one or more software applications, where the data relates to user interactions on the software application(s), communications to users on the software application(s), profile data of users of the software application(s), exposure of the user to content on the software application(s), factor data such as economic indices, expenditures relating to content, etc.

The data processing system identifies prominent features of the data and provides the prominent features to the machine learning model. An accuracy of the machine learning model output may be increased by using the prominent features. The machine learning model identifies causal relationship data among the data based on the prominent features (for example, a percent increase or decrease in a likelihood of an occurrence of a second prominent feature given one occurrence of a first prominent feature).

The data processing system then is therefore able to identify content (e.g., a pop-up video) that will promote an occurrence of the first feature (e.g., a user upload of content to the software application) that would be likely to cause an occurrence of the second feature (e.g., a purchase of a product from a software application) and provide the content to a user. Accordingly, the causal relationship data provided by the machine learning model allows the data processing system to provide content to users in a more accurate and efficient targeted manner than data processing systems that use correlation analysis or Bayesian statistics and rely on assumptions and pre-specifications of input data to make predictions about causal relationships between features of data.

At operation 205, a user provides data. In some aspects, the operations of this step refer to, or are performed by, a user as described with reference to FIG. 1. In an example, a user interacts with a website via a web browser, thereby generating data relating to the user's interactions. The web browser provides the data to the data processing system.

At operation 210, the system selects prominent features. In some aspects, the operations of this step refer to, or are performed by, a data processing apparatus as described with reference to FIGS. 1, 3, 7, 8, 10, and 13. In an example, the data processing apparatus selects prominent features of the data as described with reference to FIG. 3.

At operation 215, the system computes causal relationship data. In some aspects, the operations of this step refer to, or are performed by, a data processing apparatus as described with reference to FIGS. 1, 3, 7, 8, 10, and 13. In an example, the data processing apparatus computes causal relationship data based on the prominent features as described with reference to FIG. 3.

At operation 220, the system provides content based on the causal relationship data. In some aspects, the operations of this step refer to, or are performed by, a data processing apparatus as described with reference to FIGS. 1, 3, 7, 8, 10, and 13. In an example, the data processing apparatus selects content based on the causal relationship data and displays the selected content to the user as described with reference to FIG. 3.

FIG. 3 shows an example of an implementation of a data processing system for providing content based on causal relationship data according to aspects of the present disclosure. The example shown includes data processing system 300, data 340, prominent features 345, causal relationship data 350, and content 355. In one aspect, data processing system 300 includes data processing apparatus 305 and database 335. In one aspect, data processing apparatus 305 includes monitoring component 310, feature selection component 315, machine learning model 320, content component 325, and user interface 330.

Referring to FIG. 3, monitoring component 310 obtains data (e.g., data 340) from one or more software applications, where the data includes one or more of content data, interaction data, profile data, and factor data. As used herein, a software application refers to any computer program that executes computer code to perform a task for a user of the software application. Examples of a software application include a web browser, a smartphone or tablet app, an executable personal computer program, etc.

In some embodiments, monitoring component 310 is connected to the software application (for example, via an API) to retrieve the data from the software application. According to some aspects, monitoring component 310 is implemented in hardware or software and are executed by a processor, firmware, or any combination thereof.

In the example of FIG. 3, data 340 is a table relating to user interactions with a website A. com (“events”) visited via one or more web apps (software applications), where the User ID and Timestamp columns are index columns including values that uniquely identify each row of the table, the Event Name and the Profile Variables columns are each “feature columns”, and information in the cells in the Event Name and Profile Variables columns are “features”.

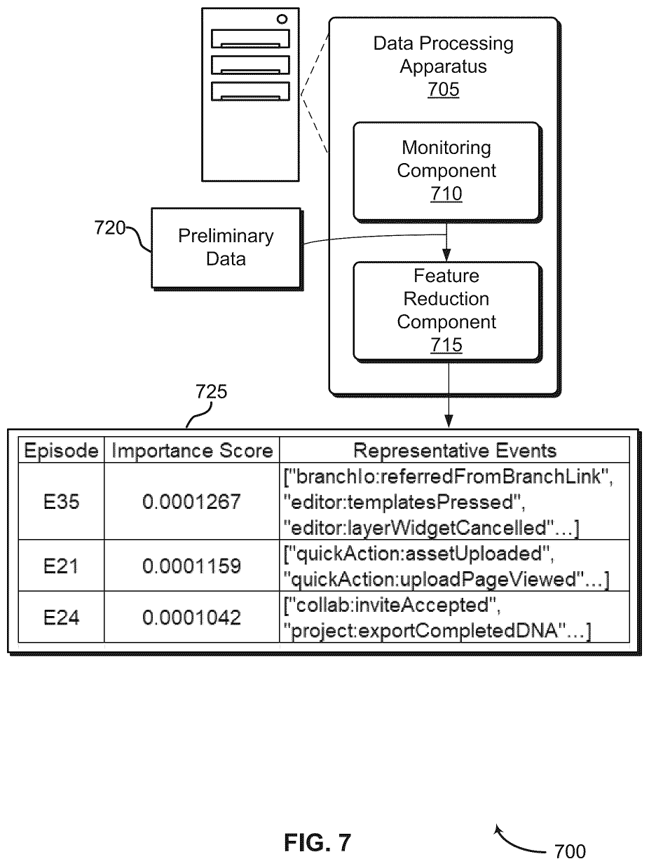

In data 340, the Event Name features include “Create Project”, “Upload Photo”, “Remove Background”, “Export”, and “Return MAU (monthly active user)” features, indexed according to a corresponding user ID and timestamp. Here, each cell within the Event Name indicates one occurrence, or “unit”, of a feature value (e.g., in data 340, both “Upload Photo” and “Return MAU” features have a feature value of one unit, indicating that they occurred once). Data 340 is an example of, or includes aspects of, the data described with reference to FIG. 7.

The data may also be obtained as one or more tables in which each feature corresponds to a column, and a value for each feature is included as a cell in the column. In an example, a column of the data may correspond to a feature “Create Project”, a cell in the column may include a value (e.g., 3, indicating that a project was created three times), and a row corresponding to the cell may include a user ID, indicating that a particular user created three projects.

In some embodiments, monitoring component 310 transforms the data into a flat format in which features are organized into time-lag bins and time-lagged with respect to target data. In some embodiments, the transformed rows are defined by a user ID and a time bucket of an occurrence of a target feature. According to some aspects, the feature transformation creates target units of features, time-lagged target units of features or metrics, profile variables, seasonality variables, or a combination thereof. According to some aspects, the transformation process is extendable to time series data, where the user ID becomes a segment.

According to some aspects, data processing apparatus 305 obtains the data based on preliminary data from the software application, where the preliminary data includes a greater number of features than the data, as described with reference to FIG. 7.

Feature selection component 315 selects one or more prominent features of the data (e.g., prominent features 345) by removing irrelevant features from the data based on a correlation analysis, thereby decreasing a runtime for machine learning model 320 and helping to avoid potential memory issues. For example, if a feature of the data is not correlated with a target feature in some way (even if the correlation is nonlinear or apparent only in the presence of another variable), then the feature does not have any conditional average treatment effects for the other features of the data, and is therefore irrelevant for machine learning model 320.

For example, in some embodiments, feature selection component 315 generates shadow data corresponding to the data by duplicating the data and randomly reassigning feature values of the duplicated data. In one example, feature selection component 315 selects the one or more prominent features by comparing the data and the shadow data. In one example, feature selection component 315 computes one or more first relevance values for the one or more prominent features based on the data and one or more second relevance values for the one or more prominent features based on the shadow data. In one example, feature selection component 315 compares the one or more first relevance values to the one or more second relevance values and selects the one more prominent features based on the comparison.

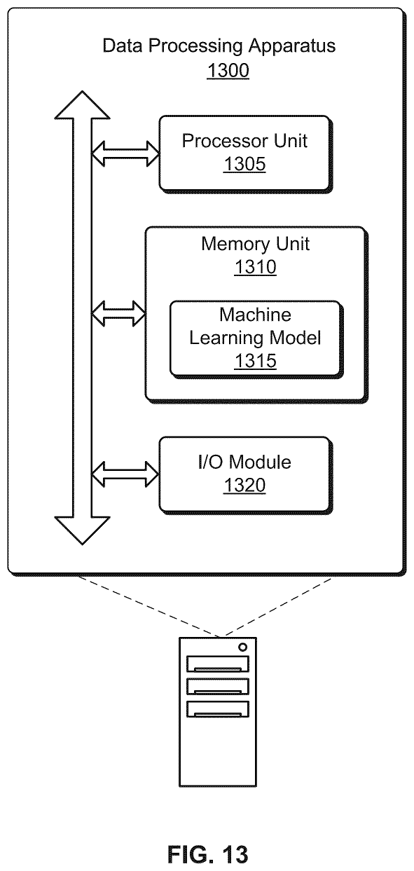

Feature selection component 315 comprises feature selection parameters (e.g., machine learning parameters) stored in a memory unit of the data processing apparatus (such as memory unit 1310 of the data processing apparatus 1300 described with reference to FIG. 13). For example, in some embodiments, feature selection component 315 comprises a Boruta algorithm and a random forest classifier.

A Boruta algorithm is a wrapper built around a random forest algorithm that attempts to capture features of the data that may affect a target feature included in the data. A “wrapper algorithm” uses a subset of features to train a machine learning model (e.g., the random forest classifier). The Boruta algorithm duplicates the features of the data and shuffles feature values of the data to obtain the shadow features. The Boruta algorithm then trains the random forest on the data to determine importance scores, for example via a Mean Decrease Accuracy or a Mean Decrease Impurity, for each of the features of the data, where a higher score indicates that the feature is more important. A random forest classifier is a meta estimator that fits a number of decision trees on various sub-samples of the data and uses averaging to improve a predictive accuracy and control over-fitting, where trees in the forest use a best-split strategy. Decision trees start with a basic question, followed by a series of narrower questions to determine an answer to the basic question. The follow-up questions comprise decision nodes in the decision tree, and allow the data to be split, where observations that fit a criteria follow a “Yes” branch and observations that do not fit the criteria follow an alternate path. The random forest treats the construction of the decision tree as a classification or regression problem, where decision nodes are labeled based on the basic question that forms the basis of the decision tree.

The random forest uses both bagging and feature randomness to create an uncorrelated forest of decision trees. “Bagging” is an example of an ensemble learning method. In ensemble learning, sets of classifiers (e.g., decision tree) and predictions of the sets of classifiers are aggregated to identify a most popular result. In bagging, a random sample of the data is selected with replacement, such that individual features of the data can be chosen more than once. The classifiers are then trained independently after several data samples are generated.

Feature randomness generates a random subset of features that ensures a low correlation among decision trees. Decision trees can be prone to problems, such as bias and overfitting. However, the random forest algorithm forms multiple decision trees into an ensemble to predict more accurate results, particularly when individual decision trees are uncorrelated with each other.

The Boruta algorithm then converts each importance score into a Z score (e.g., a number of standard deviations from a mean). The Boruta algorithm determines whether a Z score for a given feature of the data is higher than a maximum Z score for the shadow features, and if it is, selects the given feature as a prominent feature. The Boruta algorithm iteratively processes each feature of the data until each feature is either selected as a prominent feature or rejected, or until a pre-specified maximum iteration limit is reached.

Accordingly, in some embodiments, feature selection component 315 selects all relevant features, and not just a minimum set of features, as the one or more prominent features, thereby avoiding discarding a features simply because the feature is correlated or dependent on other features, as other feature selection methods may do. Furthermore, other feature selection methods that do not use Boruta may either retain too many features or may eventually result in a minimum set of features.

According to some aspects, machine learning model 320 comprises a causal inference model that uses a tree-based causal forest method to identify causal relationship data (e.g., causal relationship data 350). The causal forest model is a causal inference machine learning algorithm that repeatedly splits data (e.g., using an expanded mean squared error (EMSE)) into one or more causal sub-trees to maximize a difference across splits in a relationship between an outcome variable (e.g., the target feature) and a “treatment” feature. The causal sub-tress are used to obtain one or more graphs. The splitting uncovers how causal relationships (e.g., treatment effects, represented by the causal relationship data) vary across a sample (e.g., the one or more prominent features). The causal forest is an average of the one or more causal trees and a prediction of a treatment effect is determined by a difference in an average outcome between a treated observation and an untreated observation in final leaves of the causal trees (or nodes of graphs). Furthermore, causal forest models can discover causal relationship data for features, unlike random forest models, which can only identify features according to correlations between features.

According to some aspects, machine learning model 320 minimizes overfitting and enables an accurate estimate of the causal relationship data using honest estimation by splitting the data into two groups, where the first group is used to construct partitions in the trees of the causal forest, including any cross-validation, and the second group is used to estimate treatment effects on the leaves of the trees (e.g., the nodes of the trees), helping machine learning model 320 to avoid picking up any spurious information that would cause machine learning model 320 to provide a biased estimate of the causal relationship data. In some embodiments, machine learning model 320 produces a bootstrap sample of the for each causal tree in a causal forest and then splits the bootstrap sample in half to allow for honest estimation.

According to some aspects, machine learning model 320 builds a causal tree based on a sample (e.g., a random sample) of the first group by recursively splitting the data using the prominent features of the first group such that each split maximizes an increase in a heterogeneity of a treatment effect corresponding to the causal relationship data (for example, using the EMSE criterion). In some embodiments, each causal tree is generated using a bootstrapped random sample of the data instead of splitting the data into two groups upfront. In some embodiments, machine learning model 320 uses a random subset of the prominent features of the first group when making each split. In some embodiments, machine learning model 320 determines a causal forest as an average of a set of causal trees. In some embodiments, machine learning model 320 estimates a weighting function and uses resulting weights from the weighting function to solve a localized generalized method of moments (GMM) model to estimate the treatment effect corresponding to the causal relationship data.

In some embodiments, machine learning model 320 is optimized to estimate an average treatment effect, or a conditional average treatment effect. For example, individual treatment effects are generally unobservable, and so are estimated by machine learning model 320 instead.

For example, machine learning model 320 computes the causal relationship data for the data by optimizing a set of edges on one or more graphs based on the one or more prominent features. In some aspects, a node of the set of graphs corresponds to a feature of the data and an edge of the set of graphs corresponds to a causal relationship between features of the data. In some examples, the weight of the edge comprises the causal relationship data, or an indication of a relative degree to which a feature corresponding to a node connected to the edge causes a feature corresponding to another node connected to the edge.

In some examples, machine learning model 320 recursively updates a weight of the edge based on the data. According to some aspects, optimizes the set of edges by iteratively splitting the one or more graphs according to the causal forest algorithm until a final set of edges is determined. An example of one or more graphs represented as a heat map is described in further detail with reference to FIG. 4.

According to some aspects, each node on the graph represents a feature of the data, each link or edge represents a statistically significant driver (e.g., another feature of the data), and a link value (e.g., the edge weight) represents a treatment effect, or an effect that the statistically significant driver has on an outcome (e.g., an occurrence of a feature) while controlling for other features. In some embodiments, the causal forest modeling is performed recursively from upstream features to downstream features to construct the overall graph.

In some examples, machine learning model 320 computes an average treatment effect, where the causal relationship data is based on the average treatment effect. The average treatment effect is an average change in occurrence that the target feature experiences in response to one unit of an input feature from the prominent features, assuming an average value for the other prominent features. In some embodiments, the causal relationship data is an indication of the average treatment effect for the target feature.

In some examples, machine learning model 320 computes a conditional average treatment effect, where the causal relationship data is based on the conditional average treatment effect. The conditional average treatment effect is similar to the average treatment effect, except that the average change in occurrence is conditioned on values of one or more of the one or more prominent features, and in some embodiments the causal relationship data is an indication of the conditional average treatment effect for the target feature.

According to some aspects, machine learning model 320 reduces a scale of the prominent features by breaking the causal forest model into different components based on a forecasted time horizon, such that the causal relationship data corresponds to the specific forecast time horizon, and prior treatments are used as heterogeneity factors. In some embodiments, machine learning model 320 builds one causal forest model per time horizon, where each causal forest model uses time-lagged features corresponding to a time horizon as treatments and the remaining features as heterogeneity conditions, allowing machine learning model 320 to handle large amounts of target features, metrics, and profile variables without memory errors, and to produce graphs that can indicate cyclical relationships between features. In some embodiments, machine learning model 320 computes each causal forest model in parallel, thereby increasing a speed and scalability of machine learning model 320. The causal forests readily produce average and conditional average treatment effect estimates with uncertainty bounds as well as individual user action recommendations.

According to some aspects, machine learning model 320 finds some or all causally significant relationships among the data based on the prominent features, estimates an average treatment effect with uncertainty bounds, and displays the causally significant relationships in a graphical format (e.g., the heat map 400 described with reference to FIG. 4.). In some embodiments, the graph shows interactions between causally significant features, estimates an average size of the effect of one feature on another, enables cohort modeling, selects causally significant features for a feature forecast, enables action recommendation, or a combination thereof. In some embodiments, machine learning model 320 produces a graph for each of the prominent features, or based on time-demarcated (e.g., weekly) features that are helpful for response actioning.

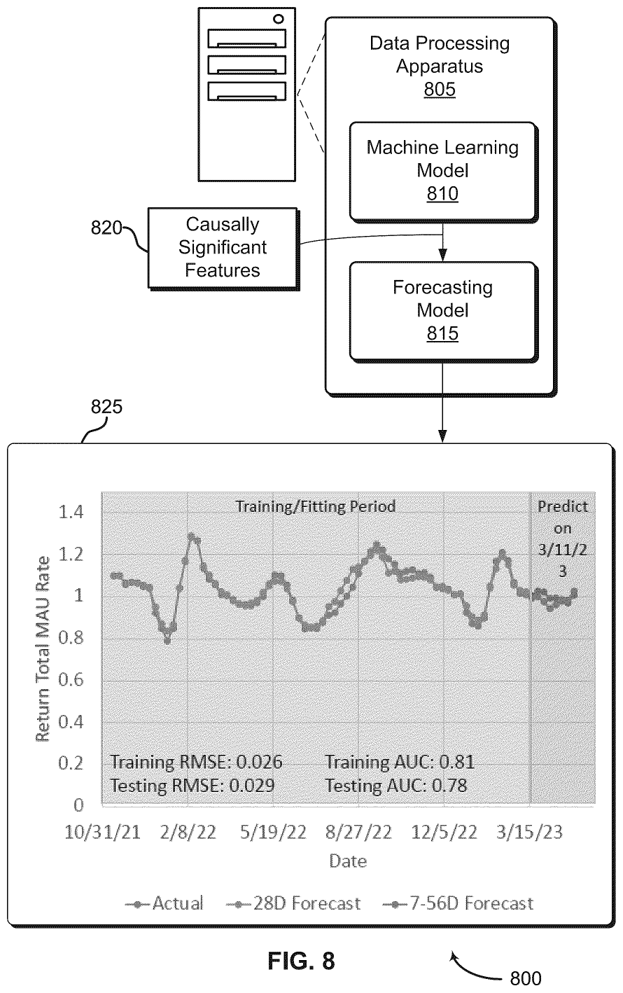

Machine learning model 320 comprises machine learning parameters stored in a memory unit of the data processing apparatus (such as memory unit 1310 of the data processing apparatus 1300 described with reference to FIG. 13). According to some aspects, machine learning model 320 comprises the one or more graphs. According to some aspects, machine learning model 320 is trained as described with reference to FIG. 12. Machine learning model 320 is an example of, or includes aspects of, the corresponding element described with reference to FIGS. 8, 9, and 13.

According to some aspects, user interface 330 provides content (e.g., content 355) to a user via the software application based on the causal relationship data. In an example, the causal relationship data indicates that for every unit of a first prominent feature, an occurrence of a second prominent feature increases by a certain percentage. Therefore, in some embodiments, data processing apparatus 305 identifies the target feature as the second prominent feature, identifies favorable causal relationship data (and a corresponding first prominent feature) for the second prominent feature, and provides content (e.g., text, an image, audio, video, or a combination thereof) to a user that would tend to promote the occurrence of the first prominent feature, and therefore the second prominent feature. According to some aspects, data processing apparatus 305 retrieves the content from a database (such as the database 140 described with reference to FIG. 1).

In some embodiments, machine learning model 320 computes a likelihood of an occurrence of an event. In an example, the causal relationship data indicates that for every project uploaded by a user to a free version of the software application, a likelihood that the user will purchase the software application increases by 12%. User interface 330 then identifies and displays content to users of the free version of the software application that encourages the users to upload projects to the software application.

In another example, machine learning model 320 generates heterogeneity trees based on the causal relationship data that show a differential impact of a feature on different cohorts of users that are automatically discovered by machine learning model 320. A heterogeneity tree is described in further detail with reference to FIG. 5. In some embodiments, data processing apparatus 305 identifies, based on the heterogeneity tree, a user cohort that is positively impacted to some degree by a prominent feature with respect to a target feature, and is therefore able to identify content that would tend to increase an occurrence of the prominent feature, and therefore the target feature. User interface 330 displays the identified (e.g., targeted) content to the user.

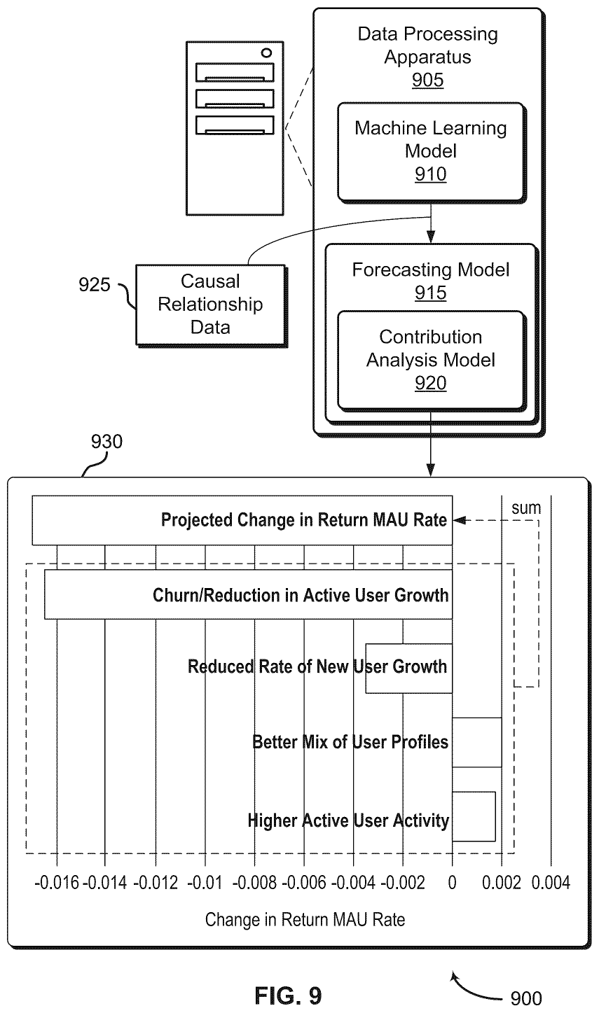

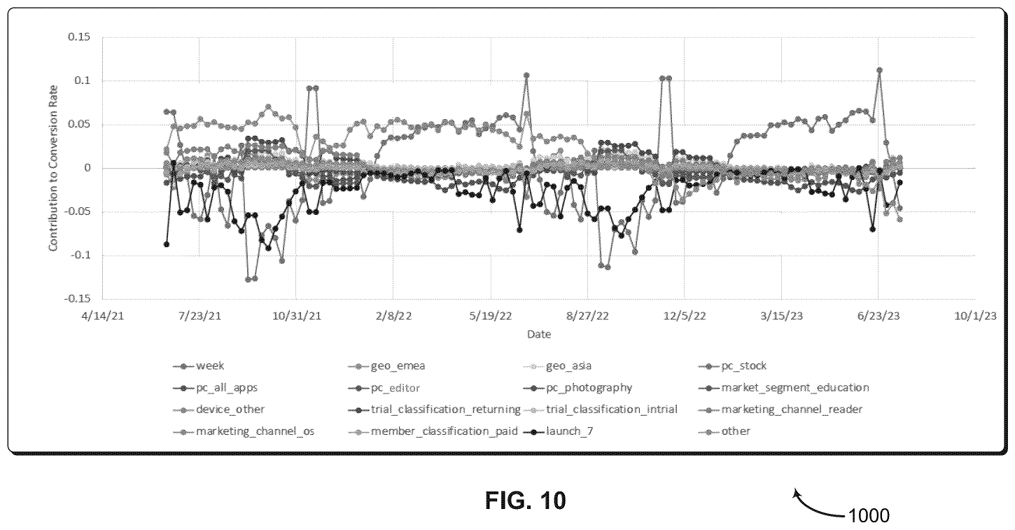

According to some aspects, data processing apparatus 305 generates forecasted data at varying granularity based on the causal relationship data as described with reference to FIG. 8. According to some aspects, data processing apparatus 305 generates a contribution analysis based on the causal relationship data as described with reference to FIGS. 9-10.

Data processing system 300 is an example of, or includes aspects of, the corresponding element described with reference to FIGS. 1, 7, 8, and 9. Data processing apparatus 305 is an example of, or includes aspects of, the corresponding element described with reference to FIGS. 1, 7, 8, 10, and 13. Database 335 is an example of, or includes aspects of, the corresponding element described with reference to FIG. 1. Causal relationship data 350 is an example of, or includes aspects of, the corresponding element described with reference to FIG. 10.

FIG. 4 shows an example of a heat map representation of one or more graphs according to aspects of the present disclosure. In one aspect, heat map 400 includes first node 405, second node 410, edge 415, and edge strength indication 420.

According to some aspects, one or more graphs of machine learning model 320 as described with reference to FIG. 3 are represented as a heat map (e.g., heat map 400) that shows relative values of causal relationship data (e.g., weights of the edges of the graph(s)) between prominent features (e.g., nodes of the graph(s)) through varying color intensities (shown by edge strength indication 420). For example, first node 405 corresponds to a first prominent feature, second node 410 corresponds to a second prominent feature, and edge 415 connects first node 405 and second node 410. Edge 415 indicates that for every unit of the first prominent feature (e.g., an upload of content by a user), a likelihood of an occurrence of the second prominent feature (a conversion, or purchase) increases by about 12%.

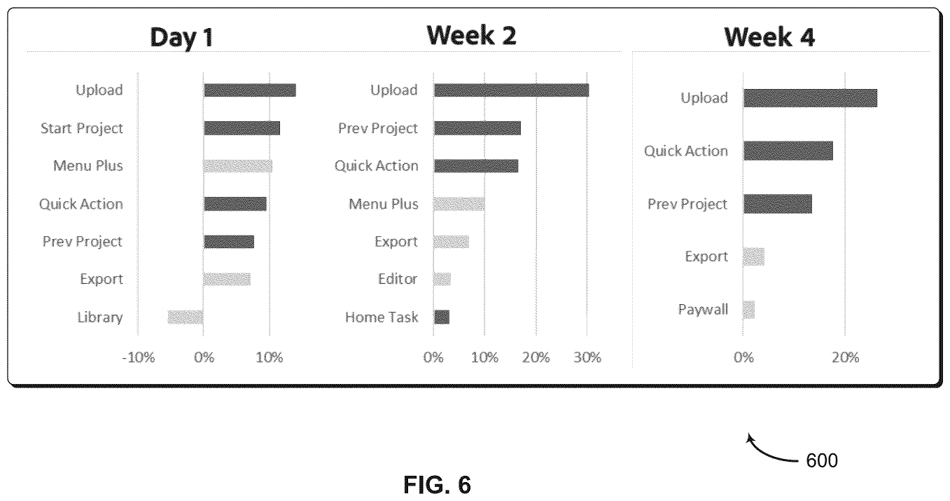

Heat map 400 can be displayed via a user interface (such as the user interface 330 described with reference to FIG. 3). In some embodiments, the one or more graphs (e.g., via heat map 400) allow a user to understand interdependencies among different features through a graphical representation. In some embodiments, the graph(s) capture influential downstream features and quantifies an effect of the downstream features on the upstream features. In some embodiments, the graph(s) allow an action recommendation to be provided based on a magnitude of causal relationship data included in the graph(s) (for example, as described in further detail with reference to FIG. 6).

In some embodiments, the graph(s) allow propagation effects of changes in the feature levels on the overall network to be understood. In some embodiments, the graph(s) allow cohorts of users to be identified who behave differently with respect to a particular outcome in response to different events/actions and quantifying the difference (for example, as described in further detail with reference to FIG. 5).

FIG. 5 shows an example of cohort modeling according to aspects of the present disclosure. In one aspect, cohort chart 500 includes first cluster 505, second cluster 510, third cluster 515, and fourth cluster 520.

According to some aspects, a machine learning model (such as the machine learning model 320 described with reference to FIG. 3) identifies a cluster based on the data, where the causal relationship data varies based on one or more characteristics of the cluster. In an example, the machine learning model performs cohort modeling and automates user cohort discovery through an expansion of causal trees to different depths, allowing for data-driven conditional average treatment effect modeling on significant covariates. In some embodiments, the identified user cohorts may be represented visually using a heterogeneity tree (e.g., cohort chart 500).

According to some aspects, the machine learning model is therefore capable of identifying significant drivers for any given user segment and is also capable of discovering significant segments for any given intervention, which is helpful in understanding a diversity of user behavior in response to certain actions. In an example, the machine learning model can be used to delve further into segments who see higher impact for certain behaviors.

Referring to FIG. 5, the machine learning model generates cohort chart 500 as a heterogeneity tree that identifies user cohorts based on differential impacts of features among the user cohorts. A relevant branch of cohort chart 500 including first cluster 505, second cluster 510, third cluster 515, and fourth cluster 520 is illustrated, and the other branches are elided. Cohort chart 500 indicates that a user's creation of a project on a software application during a fourth week of use of the software application increases a probability that the user will be retained by 24% on average, and increases a retention probability by 32% among uses who did not create a project in the third week of use, do not use a personal computer, and have less than two active sessions on the software application.

FIG. 5 also shows a variation in causal relationship data based on characteristics of the clusters. For example, the identified conditional average treatment effect (CATE) mean varies from, e.g., 0.244 in first cluster 505 to 0.323 in fourth cluster 520, according to the characteristics of the features associated with the users included in each cluster.

According to some aspects, once strategic user segments and corresponding organic drivers are derived using the machine learning model, the data processing apparatus deploys a series of personalized test campaigns to validate and approve initiatives that result in an increase in a target feature, allowing for continuous improvement with timely and data-driven interventions while maintaining an evolving system.

FIG. 6 shows an example of a representation of an action recommendation for an optimized free user web journey according to aspects of the present disclosure. The example shown includes optimized free user web journey chart 600. In some embodiments, the user journey chart is displayed by a user interface (such as the user interface described with reference to FIG. 3).

Referring to FIG. 6, according to some aspects, the graph(s) generated by the machine learning model (such as the graph(s) and machine learning model 320 described with reference to FIG. 3) enables action recommendation to optimize user journeys for users of a software application. For example, optimized free user web journey chart 600 is generated based on causal relationship data obtained for users of a free web software application, and shows an effect that user actions on the software application are likely to have over a periods of one day, two weeks, and four weeks on user retention on the software application.

For example, an uploading of a project by a user to the software application on a first day on the software application is likely to increase user retention by 10%, an uploading of a project during the first two weeks on the software application is likely to increase user retention by 30%, etc. Accordingly, the data processing apparatus can provide action recommendation content (for example, a push notification in a software application, an email to an email address associated with the user, or other communication) to users that would encourage users to take actions that would reflect the optimized user journey, or to users or entities who are employing the use of the data processing system.

FIG. 7 shows an example of an implementation of a data processing system for obtaining data based on preliminary data according to aspects of the present disclosure. The example shown includes data processing system 700, preliminary data 720, and data 725. In one aspect, data processing system 700 includes data processing apparatus 705. In one aspect, data processing apparatus 705 includes monitoring component 710 and feature reduction component 715.

In the example of FIG. 7, monitoring component 710 obtains preliminary data 720 from a software application (such as the software application described with reference to FIG. 3), where preliminary data 720 is data as described herein but includes more features than the data. In some embodiments, feature reduction component 715 reduces the number of features of the preliminary data using neural network model-based feature combination or variance inflation factor-based feature elimination to obtain the data (e.g., data 725).

In one example, feature reduction component 715 either aggregates or removes very highly correlated features from the preliminary data using variance inflation factor (VIF), a measure of multicollinearity, to obtain the data and increase an ability of a machine learning model (such as the machine learning model 320 described with reference to FIG. 3) to process the prominent features derived from the data.

In another example, feature reduction component 715 employs one or more artificial neural networks to use episode modeling, in which sequences of features are combined into higher level features, and linearly dependent features are aggregated into the higher-level features to obtain episodes, or clusters, of features, which are provided as the data.

For example, in some embodiments, feature reduction component 715 treats each user's software application usage path as a text document and leverages natural language processing (NLP) algorithms to discover a sequential pattern and further provide insights on an importance of the identified sequential pattern to a target feature. Natural language processing (NLP) refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features. These models can express the relative probability of multiple answers.

In an example implementation, for user software application usage data, the tracked user path is mostly a stream of events for different tasks over time. Feature reduction component 715 preprocess the preliminary data by breaking the user path into smaller sequences. Then feature reduction component 715 extracts all possible sub-sequences within user sessions and rank the extracted sub-sequences according to importance scores.

In the example implementation, feature reduction component 715 selects top N sequences of the extracted sub-sequences, where N is tuned by a specified event coverage rate threshold, generates sequence embeddings using a term frequency-inverse document frequency (TF-IDF) embedding for the top N sequences, and applies a K-means clustering algorithm on the sequence embeddings to retrieve K episodes, or clusters of features, where K is determined by algorithmically locating a saturation point on a diagram of a silhouette coefficient by a number of clusters. In some embodiments, the K episodes are provided as data 725.

In the example implementation, feature reduction component 715 then treats all sequences within one episode as one document and all of the K episodes as a corpus, and adopts a text summarization technique such as TF-IDF to extract keyword events as labels for the discovered episodes. In the example of FIG. 7, data 725 is a data table including Episode and Importance Score indices and a Representative Events feature, where each row includes multiple features.

According to some aspects, feature reduction component 715 is implemented in hardware or software and are executed by a processor, firmware, or any combination thereof. According to some aspects, feature reduction component 715 comprises feature reduction parameters (e.g., machine learning parameters) stored in a memory unit of the data processing apparatus (such as memory unit 1310 of the data processing apparatus 1400 described with reference to FIG. 13).

Data processing system 700 is an example of, or includes aspects of, the corresponding element described with reference to FIGS. 1, 3, 8, and 9. Data processing apparatus 705 is an example of, or includes aspects of, the corresponding element described with reference to FIGS. 1, 3, 8, 10, and 13. Monitoring component 710 and data 725 are examples of, or include aspects of, the corresponding elements described with reference to FIG. 3.

FIG. 8 shows an example of an implementation of a data processing system 800 for generating forecasted data according to aspects of the present disclosure. The example shown includes data processing system 800, causally significant features 820, and forecasted data representation 825. In one aspect, data processing system 800 includes data processing apparatus 805. In one aspect, data processing apparatus 805 includes machine learning model 810 and forecasting model 815.

According to some aspects, forecasting model 815 generates forecasted data at varying granularity (e.g., illustrated by forecasted data representation 825) based on the causal relationship data. In an example, data processing apparatus extends machine learning model 810 to produce forecasting model 815 as a causally informed user propensity and forecast model. In some embodiments, forecasting model 815 predicts a value of a target feature based on causally significant features 820 identified by machine learning model 810 according to the causal relationship data for the prominent features, resulting in a model that is faster and more accurate than existing propensity and forecasting models because it cannot pick up spurious correlations from causally insignificant features. Therefore, forecasting model 815 can be considered a causal forecast and propensity model.

Forecasting model 815 can therefore detect deviations from a plan to enable precise response actioning. According to some aspects, forecasting model 815 supports forecasting for multiple different segments. In some embodiments, entirely different models can be built for each segment.

According to some aspects, forecasting model 815 comprises forecasting parameters (e.g., machine learning parameters) stored in a memory unit of data processing apparatus 805 (such as the memory unit 1310 described with reference to FIG. 13).

In some embodiments, forecasting model 815 comprises a classification model based on a gradient boosting algorithm, such as XGBoost. In some embodiments, forecasting model 815 comprises a regression model. In some embodiments, forecasting model 815 comprises a set of models corresponding to each forecast time horizon.

In some embodiments, forecasting model 815 comprises a transformer. A transformer comprises one or more artificial neural networks (ANNs) comprising attention mechanisms that enable the transformer to weigh the importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

An attention mechanism allows an ANN to focus on different parts of an input sequence when making predictions or generating output. Some sequence models process an input sequence sequentially, maintaining an internal hidden state that captures information from previous steps. However, this sequential processing can lead to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

In some embodiments, forecasting model 815 comprises a long short-term memory (LSTM). An LSTM is a form of recurrent neural network (RNN) that includes feedback connections. In one example, an LSTM includes a cell, an input gate, an output gate and a forget gate. The cell stores values for a certain amount of time, and the gates dictate the flow of information into and out of the cell. LSTM networks may be used for making predictions based on series data where there can be gaps of unknown size between related information in the series. LSTMs can help mitigate the vanishing gradient (and exploding gradient) problems when training an RNN.

An RNN is a class of ANN in which connections between nodes form a directed graph along an ordered (i.e., a temporal) sequence, enabling the RNN to model temporally dynamic behavior such as predicting what element should come next in a sequence. Examples of an RNN include a finite impulse recurrent network (characterized by nodes forming a directed acyclic graph) and an infinite impulse recurrent network (characterized by nodes forming a directed cyclic graph).

According to some aspects, forecasting model 815 further comprises an autoregressive residual correction model to correct systematic errors due to data gaps in forecasting model 815. In some embodiments, segments are used to break a single autoregressive residual correction model into multiple residual correction models.

In the example of FIG. 8, forecasted data representation 825 shows forecasted values for return total monthly active users (MAU) on a software application over 7 to 56 days, forecasted and actual values for the return total MAU over a period of time preceding the 7 to 56 days, and training values from the autoregressive residual correction model.

Data processing system 800 is an example of, or includes aspects of, the corresponding element described with reference to FIGS. 1, 3, 7, and 9. Data processing apparatus 805 is an example of, or includes aspects of, the corresponding element described with reference to FIGS. 1, 3, 7, 10, and 13. Machine learning model 810 is an example of, or includes aspects of, the corresponding element described with reference to FIGS. 1, 3, 9, and 13. Forecasting model 815 is an example of, or includes aspects of, the corresponding element described with reference to FIG. 9.

FIG. 9 shows an example of an implementation of a data processing system for obtaining a contribution analysis according to aspects of the present disclosure. The example shown includes data processing system 900, causal relationship data 925, and contribution analysis representation 930. In one aspect, data processing system 900 includes data processing apparatus 905. In one aspect, data processing apparatus 905 includes machine learning model 910 and forecasting model 915. In one aspect, forecasting model 915 includes contribution analysis model 920.

According to some aspects, contribution analysis model 920 generates a contribution analysis based on the causal relationship data 925, thereby explaining why one feature changed in terms of one or more other features in a quantitative way for a purpose of response actioning. In an example, contribution analysis model 920 uses an ability of machine learning model 910 to produce granular conditional average treatment effects at a user level. Contribution analysis model 920 incorporates a CATE into the contribution analysis output if the user was exposed to the treatment.

Because treatments potentially come from different causal forests models of contribution analysis model 920 (based on different time horizons), aspects of contribution analysis model 920 rescale the causal forest models, within uncertainty bounds, to match predicted propensities from forecasting model 915. Contribution analysis model 920 then aggregates the results to determine which factors have the largest impact on some observed change in the target feature.

Contribution analysis model 920 therefore reduces time-to-discovery for why a value of a feature declined over a time period, what response actions can be taken to resolve any forecasted declines in the value of a feature and helps to explains why a specific user took a specific action.

In the example of FIG. 9, contribution analysis representation 930 surfaces a projected change in return MAU rate over time and explains the change in terms of one or upstream features (here, churn/reduction in active user growth, reduced rate of new user growth, better mix of user profiles, and higher active user activity). A contribution analysis represented as a time series is described with reference to FIG. 10.

According to some aspects, data processing apparatus 905 performs scenario modeling. Contribution analysis and scenario modeling use similar technology according to different processing techniques. According to some aspects, data processing apparatus 905 performs scenario analysis by using causal relationship data 925 to determine how a feature will increase a user's propensity. In performing scenario modeling, data processing apparatus 905 uses estimated treatment effects to simulate an increase in a propensity of a user towards a target feature. Aggregate user propensities show an impact on the overall target features.

In some embodiments, causal relationship data 925 is provided by conditional average treatment effects determined by machine learning model 910, similarly to the contribution analysis. In some embodiments, given a target value of a feature, data processing apparatus 905 proposes a minimum number of actions needed to reach the target value by iterating through conditional average treatment effects computed for individual users, and therefore demonstrates how values of upstream features would need to change to hit a specific target value.

According to some aspects, contribution analysis model 920 comprises contribution analysis parameters (e.g., machine learning parameters) stored in a memory unit of data processing apparatus 905 (such as the memory unit 1310 described with reference to FIG. 13).

Data processing system 900 is an example of, or includes aspects of, the corresponding element described with reference to FIGS. 1, 3, 7, and 8. Data processing apparatus 905 is an example of, or includes aspects of, the corresponding element described with reference to FIGS. 1, 3, 7, 8, and 13. Machine learning model 910 is an example of, or includes aspects of, the corresponding element described with reference to FIGS. 1, 3, 8, and 13. Forecasting model 915 is an example of, or includes aspects of, the corresponding element described with reference to FIG. 8. Causal relationship data 925 is an example of, or includes aspects of, the corresponding element described with reference to FIG. 3.

FIG. 10 shows an example of a representation of a contribution analysis as a time series according to aspects of the present disclosure. Referring to FIG. 10, contribution analysis representation 1000 surfaces a contribution analysis output by a contribution analysis model (such as the contribution analysis model 920 described with reference to FIG. 9) of a contribution to a conversion rate by various features as a time series.

### Data Processing

FIG. 11 shows an example of a method 1100 for providing content based on causal relationship data according to aspects of the present disclosure. Referring to FIG. 11, a data processing system (such as the data processing system 300 described with reference to FIG. 3) provides content to a user based on causal relationship data obtained using a causal inference machine learning model (such as the machine learning model 320 described with reference to FIG. 3).

In one example, the data processing system obtains data from one or more software applications, where the data relates to user interactions on the software application(s), communications to users on the software application(s), profile data of users of the software application(s), exposure of the user to content on the software application(s), factor data such as economic indices, expenditures relating to content, etc.

The data processing system identifies prominent features of the data and provides the prominent features to the machine learning model. The accuracy of the machine learning model output may be increased by using the prominent features. The machine learning model identifies causal relationship data among the data based on the prominent features (for example, a percent increase or decrease in a likelihood of an occurrence of a second prominent feature given one occurrence of a first prominent feature).

The data processing system then is therefore able to identify content (e.g., a pop-up video) that will promote an occurrence of the first feature (e.g., a user upload of content to the software application) that would be likely to cause an occurrence of the second feature (e.g., a purchase of a product from a software application) and provide the content to a user. Accordingly, the causal relationship data provided by the machine learning model allows the data processing system to provide content to users in a more accurate and efficient targeted manner than data processing systems that use correlation analysis because the machine learning model properly controls for various confounders. Furthermore, the machine learning model is more accurate, efficient and easier to deploy than processes that use Bayesian statistics and rely on assumptions and pre-specifications of input data to make predictions about causal relationships between features of data.

Furthermore, some embodiments of the present disclosure can use the causal relationship data provided by the machine learning model to discover user cohorts or segments defined by differences between causal relationships among the feature data. Additionally, some embodiments of the present disclosure generate forecasted data at varying granularity based on the causal relationship data, allowing an entity to make informed decisions at different time windows relating to target features of interest to the entity. Still further, some embodiments of the present disclosure generate a contribution analysis based on the causal relationship data, allowing an entity to understand which features contributed to increases or decreases in occurrences of a target features of interest.

At operation 1105, the system obtains data from a software application, where the data includes one or more of content data, interaction data, profile data, and factor data. In some cases, the operations of this step refer to, or may be performed by, a monitoring component as described with reference to FIG. 3. In an example, the monitoring component obtains the data as described with reference to FIG. 3. In some embodiments, the monitoring component obtains preliminary data as described with reference to FIG. 7, and a feature reduction component obtains the data based on the preliminary data as described with reference to FIG. 7.

At operation 1110, the system generates shadow data corresponding to the data by duplicating the data and randomly reassigning feature values of the duplicated data. In some cases, the operations of this step refer to, or may be performed by, a feature selection component as described with reference to FIG. 3. In an example, the feature selection component generates the shadow data as described with reference to FIG. 3.

At operation 1115, the system selects one or more prominent features by comparing the data and the shadow data. In some cases, the operations of this step refer to, or may be performed by, a feature selection component as described with reference to FIG. 3. In an example, the feature selection component selects the one or more prominent features as described with reference to FIG. 3.

At operation 1120, the system computes causal relationship data for the data by optimizing a set of edges on one or more graphs based on the one or more prominent features. In some cases, the operations of this step refer to, or may be performed by, a machine learning model as described with reference to FIGS. 1, 3, 8, 10, and 13. In an example, the machine learning model computes the causal relationship data as described with reference to FIGS. 3 and 4.

At operation 1125, the system provides content to a user via the software application based on the causal relationship data. In some cases, the operations of this step refer to, or may be performed by, a user interface as described with reference to FIG. 3. In an example, the user interface provides the content to the user as described with reference to FIG. 3.

According to some aspects, a clustering component identifies a cluster based on the data as described with reference to FIG. 5. In some embodiments, the causal relationship data varies based on one or more characteristics of the cluster as described with reference to FIG. 5. According to some aspects, the data processing system generates action recommendations based on the causal relationship data as described with reference to FIG. 6.

According to some aspects, a forecasting model generates forecasted data at varying granularity based on the causal relationship data as described with reference to FIG. 8. According to some aspects, a contribution analysis model generates a contribution analysis based on the causal relationship data as described with reference to FIGS. 9-10.

Accordingly, a method for data processing is described. One or more aspects of the method include obtaining data from a software application, wherein the data includes one or more of content data, interaction data, profile data, and factor data; generating shadow data corresponding to the data by duplicating the data and randomly reassigning feature values of the duplicated data; selecting one or more prominent features by comparing the data and the shadow data; computing causal relationship data for the data by optimizing a plurality of edges on one or more graphs based on the one or more prominent features; and providing content to a user via the software application based on the causal relationship data.

Some examples of the method further include computing an average treatment effect or a conditional average treatment effect, wherein the causal relationship data is based on the average treatment effect or the conditional average treatment effect.

Some examples of the method further include obtaining preliminary data from the software application. Some examples further include reducing a number of features of the preliminary data to obtain the data. Some examples of the method further include reducing the number of features of the preliminary data using neural network model-based feature combination or variance inflation factor-based feature elimination.

Some examples of the method further include computing one or more first relevance values for the one or more prominent features based on the data and one or more second relevance values for the one or more prominent features based on the shadow data. Some examples further include comparing the one or more first relevance values to the one or more second relevance values, wherein the one or more prominent features are selected based on the comparison between the one or more first relevance values and the one or more second relevance values.

In some aspects, a node of the plurality of graphs corresponds to a feature of the data and an edge of the plurality of graphs corresponds to a causal relationship between features of the data. Some examples of the method further include recursively updating a weight of the edge based on the data. Some examples of the method further include identifying a cluster based on the data, wherein the causal relationship data varies based on one or more characteristics of the cluster.

Some examples of the method further include generating forecasted data at varying granularity based on the causal relationship data. Some examples of the method further include generating a contribution analysis based on the causal relationship data.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Training

FIG. 12 shows an example of a method 1200 for training a machine learning model according to aspects of the present disclosure. Referring to FIG. 12, a machine learning model of a data processing apparatus (such as the machine learning model 1415 of data processing apparatus 1400) is trained to predict causal relationships among features of data based on one or more graphs.

At operation 1205, the system obtains a training set including data with one or more of content data, interaction data, profile data, and factor data. In some cases, the operations of this step refer to, or may be performed by, a monitoring component as described with reference to FIG. 3. In some embodiments, the data included in the training set is similar to the data described with refence to FIG. 3.

At operation 1210, the system generates shadow data corresponding to the data by duplicating the data and randomly reassigning feature values of the duplicated data. In some cases, the operations of this step refer to, or may be performed by, a feature selection component as described with reference to FIG. 3. In some embodiments, the feature selection component generates the shadow data as described with reference to FIG. 3.

At operation 1215, the system selects one or more prominent features by comparing the data and the shadow data. In some cases, the operations of this step refer to, or may be performed by, a feature selection component as described with reference to FIG. 3. In some embodiments, the feature selection selects the one or more prominent features as described with reference to FIG. 3.

At operation 1220, the system computes causal relationship data for the data by optimizing a set of edges on one or more graphs based on the one or more prominent features. In some cases, the operations of this step refer to, or may be performed by, a machine learning model as described with reference to FIGS. 1, 3, 8, 10, and 13. In some embodiments, the machine learning model computes the causal relationship data as described with reference to FIG. 3.

According to some aspects, the machine learning model minimizes overfitting and enable an accurate estimate of the causal relationship data using honest estimation by splitting the training data into two groups, where the first group is used to construct partitions in the trees of the causal forest, including any cross-validation, and the second group is used to estimate treatment effects on the leaves of the trees (e.g., the nodes of the trees), helping the machine learning model to avoid picking up any spurious information that would cause the machine learning model to provide a biased estimate of the causal relationship data. In some embodiments, the machine learning model produces a bootstrap sample of the for each causal tree in a causal forest and then splits the bootstrap sample in half to allow for honest estimation.

According to some aspects, the machine learning model builds a causal tree based on a sample (e.g., a random sample) of the first group by recursively splitting the training data using the prominent features of the first group such that each split maximizes an increase in a heterogeneity of a treatment effect corresponding to the causal relationship data (for example, using the EMSE criterion). In some embodiments, each causal tree is generated using a bootstrapped random sample of the training data. In some embodiments, the machine learning model uses a random subset of the prominent features of the first group when making each split. In some embodiments, the machine learning model determines a causal forest as an average of a set of causal trees. In some embodiments, the machine learning model estimates a weighting function and uses resulting weights from the weighting function to solve a localized generalized method of moments (GMM) model to estimate the treatment effect corresponding to the causal relationship data.

At operation 1225, the system trains, using the training set, the machine learning model to discover causal relationships based on the one or more graphs. In some cases, the operations of this step refer to, or may be performed by, a machine learning model as described with reference to FIG. 13.

According to some aspects, the machine learning model computes a loss value based on the causal relationship data and the data. In an example, the machine learning model determines the loss value according to the EMSE. The parameters of the machine learning model are updated based on the loss value. In an example, the parameters of the machine learning model are updated such that the heterogeneity of the treatment effect corresponding to the causal relationship data is maximized according to the EMSE.

Accordingly, a method for training a machine learning model is described. One or more aspects of the method include obtaining a training set including data with one or more of content data, interaction data, profile data, and factor data; generating shadow data corresponding to the data by duplicating the data and randomly reassigning feature values of the duplicated data; selecting one or more prominent features by comparing the data and the shadow data; computing causal relationship data for the data by optimizing a plurality of edges on one or more graphs based on the one or more prominent features; and training, using the training set, the machine learning model to predict causal relationships based on the one or more graphs.

Some examples further include computing a loss value based on the causal relationship data and the data. Some examples further include updating parameters of the machine learning mode based on the loss value.

Some examples of the method further include computing one or more first relevance values for the one or more prominent features based on the data and one or more second relevance values for the one or more prominent features based on the shadow data. Some examples further include comparing the one or more first relevance values to the one or more second relevance values, wherein the one more prominent features are selected based on the comparison between the one or more first relevance values and the one or more second relevance values. Some examples of the method further include recursively updating a weight of the edge based on the data.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Computing Device

FIG. 13 shows an example implementation of a data processing apparatus according to aspects of the present disclosure. Data processing apparatus 1300 is an example of, or includes aspects of, the corresponding element described with reference to FIGS. 1, 3, and 7-9. In some embodiments, data processing apparatus 1300 includes processor unit 1305, memory unit 1310, machine learning model 1315, and I/O module 1320.

Processor unit 1305 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1305 is configured to operate a memory array using a memory controller. In other cases, a memory controller is integrated into processor unit 1305. In some cases, processor unit 1305 is configured to execute computer-readable instructions stored in memory unit 1310 to perform various functions. In some aspects, processor unit 1305 includes special purpose components for modem processing, baseband processing, digital signal processing, or transmission processing.

Memory unit 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1305 to perform various functions described herein.

In some cases, memory unit 1310 includes a basic input/output system (BIOS) that controls basic hardware or software operations, such as an interaction with peripheral components or devices. In some cases, memory unit 1310 includes a memory controller that operates memory cells of memory unit 1310. For example, the memory controller may include a row decoder, column decoder, or both. In some cases, memory cells within memory unit 1310 store information in the form of a logical state.

According to some aspects, data processing apparatus 1300 uses one or more processors of processor unit 1305 to execute instructions stored in memory unit 1310 to perform functions described herein. For example, the data processing apparatus 1300 may obtain data from a software application, wherein the data includes one or more of content data, interaction data, profile data, and factor data; generate shadow data corresponding to the data by duplicating the data and randomly reassigning feature values of the duplicated data; select one or more prominent features by comparing the data and the shadow data; compute causal relationship data for the data by optimizing a plurality of edges on one or more graphs based on the one or more prominent features; and provide content to a user via the software application based on the causal relationship data.

Memory unit 1310 may include a machine learning model 1315 trained to compute causal relationship data for the data by optimizing a plurality of edges on one or more graphs based on the one or more prominent features. Machine learning model 1315 is an example of, or includes aspects of, the corresponding element described with reference to FIGS. 1, 3, 8, and 9.

In some embodiments, machine learning model 1315 comprises an artificial neural network (ANN). An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 1315 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Parameters of machine learning model 1315 can be learned or estimated from training data and then used to make predictions or perform tasks based on learned patterns and relationships in the data. In some examples, the parameters are adjusted during the training process to optimize a loss function or maximize a performance metric (e.g., as described with reference to FIG. 12). The goal of the training process may be to find optimal values for the parameters that allow machine learning model 1315 to make accurate predictions or perform well on the given task.

Accordingly, the node weights can be adjusted to improve the accuracy of the output (i.e., by optimizing a loss which corresponds in some way to the difference between the current result and the target result). The weight of an edge increases or decreases the strength of the signal transmitted between nodes. For example, during the training process, an algorithm adjusts machine learning parameters to optimize an error or loss between predicted outputs and actual targets according to optimization techniques like gradient descent, stochastic gradient descent, or other optimization algorithms. Once the machine learning parameters are learned from the training data, machine learning model 1315 can be used to make predictions on new, unseen data (i.e., during inference).

According to some aspects, a monitoring component (such as monitoring component 310 as described with reference to FIG. 3) obtains a training set including data with one or more of content data, interaction data, profile data, and factor data. In some examples, machine learning model 1315 is trained using the training set to predict causal relationships based on the one or more graphs. In some examples, machine learning model 1315 computes a loss value based on the causal relationship data and the data. In some examples, the parameters of machine learning model 1315 are updated based on the loss value.

I/O module 1320 receives inputs from and transmits outputs of the data processing apparatus 1300 to other devices or users. For example, I/O module 1320 receives inputs for machine learning model 1315 and transmits outputs of machine learning model 1315.

Accordingly, a system and an apparatus for data processing is described. One or more aspects of the apparatus include at least one processor; at least one memory storing instructions executable by the at least one processor; a feature selection component comprising feature selection parameters stored in the at least one memory, wherein the feature selection component is configured to generate shadow data and select one or more prominent features by comparing data and the shadow data; and a machine learning model comprising machine learning parameters stored in the at least one memory and trained to compute causal relationship data for the data by optimizing a plurality of edges on one or more graphs based on the one or more prominent features.

Some examples of the system and the apparatus further include a monitoring component configured to obtain the data from a software application, wherein the data includes one or more of content data, interaction data, profile data, and factor data. Some examples of the system and the apparatus further include a user interface configured to provide content to a user via a software application based on the causal relationship data. Some examples of the system and the apparatus further include a feature reduction component configured to reduce a number of features of preliminary data to obtain the data.

Some examples of the system and the apparatus further include a forecasting model configured to generate forecasted data at varying granularity based on the causal relationship data. Some examples of the system and the apparatus further include a contribution analysis model configured to generate a contribution analysis based on the causal relationship data.

The description and drawings described herein represent example configurations and do not represent all the implementations within the scope of the claims. For example, the operations and steps may be rearranged, combined or otherwise modified. Also, in some embodiments, structures and devices are represented in the form of block diagrams to represent the relationship between components and avoid obscuring the described concepts. In some embodiments, similar components or features have the same name but have different reference numbers corresponding to different figures.

Some modifications to the disclosure may be readily apparent to those skilled in the art, and the principles defined herein are applicable to other variations without departing from the scope of the disclosure. Thus, the disclosure is not limited to the examples and designs described herein but is to be accorded the broadest scope consistent with the principles and novel features disclosed herein.

According to some aspects, the functions described herein are implemented in hardware or software and are executed by a processor, firmware, or any combination thereof. In some embodiments, if implemented in software executed by a processor, the functions are stored in the form of instructions or code on a computer-readable medium.

Computer-readable media includes both non-transitory computer storage media and communication media including any medium that facilitates transfer of code or data. In some embodiments, a non-transitory storage medium is any available medium that is accessible by a computer. Also, in some embodiments, connecting components are properly termed computer-readable media. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” can be based on both condition A and condition B. In other words, the phrase “based on” shall be construed to mean “based at least in part on. ” Also, the words “a” or “an” indicate “at least one. ”

What is claimed is:

1. A method implemented by a computing device including at least one processor and at least one memory, the method comprising:
obtaining, by the computing device, data from a software application, wherein the data includes one or more of content data, interaction data, profile data, and factor data;
generating by the computing device, shadow data corresponding to the data by duplicating the data and randomly reassigning feature values of the duplicated data;
selecting by the computing device, one or more prominent features by comparing the data and the shadow data;
computing, using a machine learning model, causal relationship data for the data by optimizing a plurality of edges on one or more graphs based on the one or more prominent features; and
providing, by the computing device, content to a user via the software application based on the causal relationship data.

2. The method of claim 1, further comprising:
computing, using the machine learning model, an average treatment effect or a conditional average treatment effect, wherein the causal relationship data is based on the average treatment effect or the conditional average treatment effect.

3. The method of claim 1, wherein obtaining the data comprises:
obtaining preliminary data from the software application; and
reducing a number of features of the preliminary data to obtain the data.

4. The method of claim 3, wherein obtaining the data further comprises:
reducing the number of features of the preliminary data using neural network model-based feature combination or variance inflation factor-based feature elimination.

5. The method of claim 1, wherein selecting the one or more prominent features comprises:
computing one or more first relevance values for the one or more prominent features based on the data and one or more second relevance values for the one or more prominent features based on the shadow data; and
comparing the one or more first relevance values to the one or more second relevance values, wherein the one more prominent features are selected based on the comparison between the one or more first relevance values and the one or more second relevance values.

6. The method of claim 1, wherein:
a node of the plurality of graphs corresponds to a feature of the data and an edge of the plurality of graphs corresponds to a causal relationship between features of the data.

7. The method of claim 6, wherein computing the causal relationship data comprises:
recursively updating a weight of the edge based on the data.

8. The method of claim 1, further comprising:
identifying, using the machine learning model, a cluster based on the data, wherein the causal relationship data varies based on one or more characteristics of the cluster.

9. The method of claim 1, further comprising:
generating forecasted data at varying granularity based on the causal relationship data.

10. The method of claim 1, further comprising:
generating a contribution analysis based on the causal relationship data.

11. A method for training a machine learning model implemented by a computing device including at least one processor and at least one memory, the method comprising:
obtaining, by the computing device, a training set including data with one or more of content data, interaction data, profile data, and factor data;
generating, by the computing device, shadow data corresponding to the data by duplicating the data and randomly reassigning feature values of the duplicated data;
selecting, by the computing device, one or more prominent features by comparing the data and the shadow data;
computing, using a machine learning model, causal relationship data for the data by optimizing a plurality of edges on one or more graphs based on the one or more prominent features; and
training, using the training set, the machine learning model to predict causal relationships based on the one or more graphs.

12. The method of claim 11, wherein training the machine learning model comprises:
computing a loss value based on the causal relationship data and the data; and
updating parameters of the machine learning mode based on the loss value.

13. The method of claim 11, wherein selecting the one or more prominent features comprises:
computing one or more first relevance values for the one or more prominent features based on the data and one or more second relevance values for the one or more prominent features based on the shadow data; and
comparing the one or more first relevance values to the one or more second relevance values, wherein the one more prominent features are selected based on the comparison between the one or more first relevance values and the one or more second relevance values.

14. The method of claim 11, further comprising:
recursively updating a weight of the edge based on the data.

15. An apparatus for data processing, the apparatus comprising:
at least one processor;
at least one memory storing instructions executable by the at least one processor;
a feature selection component comprising feature selection parameters stored in the at least one memory, wherein the feature selection component is configured to generate shadow data and select one or more prominent features by comparing data and the shadow data; and
a machine learning model comprising machine learning parameters stored in the at least one memory and trained to compute causal relationship data for the data by optimizing a plurality of edges on one or more graphs based on the one or more prominent features.

16. The apparatus of claim 15, further comprising:
a monitoring component configured to obtain the data from a software application, wherein the data includes one or more of content data, interaction data, profile data, and factor data.

17. The apparatus of claim 15, further comprising:
a user interface configured to provide content to a user via a software application based on the causal relationship data.

18. The apparatus of claim 15, further comprising:
a feature reduction component configured to reduce a number of features of preliminary data to obtain the data.

19. The apparatus of claim 15, further comprising:
a forecasting model configured to generate forecasted data at varying granularity based on the causal relationship data.

20. The apparatus of claim 15, further comprising:
a contribution analysis model configured to generate a contribution analysis based on the causal relationship data.
